(19) United States
(12) Patent Application Publication
(10) Pub. No.: US 2014/0074512 A1
(43) Pub. Date: Mar. 13, 2014

(54) SYSTEMS AND METHODS FOR VEHICLE RENTAL INSURANCE

(71) Applicants: G. Anthony Hare, Simsbury, CT (US); Jennifer C. Lui, Glastonbury, CT (US); Laura A. Schiavone, Windsor, CT (US); Caroline Schnog, West Hartford, CT (US); Jeffrey L. Vanags, West Hartford, CT (US); Kimberly H. Yerino, New Haven, CT (US)

(72) Inventors: G. Anthony Hare, Simsbury, CT (US); Jennifer C. Lui, Glastonbury, CT (US); Laura A. Schiavone, Windsor, CT (US); Caroline Schnog, West Hartford, CT (US); Jeffrey L. Vanags, West Hartford, CT (US); Kimberly H. Yerino, New Haven, CT (US)

(73) Assignee: The Travelers Indemnity Company, Hartford, CT (US)

(21) Appl. No.: 13/607,148

(22) Filed: Sep. 7, 2012

(51) Int. Cl. G06Q 40/08

(52) U.S. Cl. 705/4

(57) ABSTRACT

Exemplary embodiments provide systems, methods, and products that that offer, characterize, price, and/or sell vehicle rental insurance coverage in terms of the type of vehicle, class of vehicle, or exact vehicle that the customer will obtain as a rental, instead of, or in addition to, a dollar limit per day and/or a dollar limit per incident. Various embodiments allow insurers to offer and calculate a premium price for, and/or allow consumers to choose and pay for, coverage specified according to the type of vehicle, class of vehicle, and/or exact vehicle desired as a rental replacement for an insured vehicle. Various embodiments also allow insurers to offer and calculate a premium price for, and allow consumers to choose and pay for, optional add-ons for the rental vehicle, such as a navigation system and/or a child safety seat.

### BACKGROUND OF THE INVENTION

Vehicle insurance is insurance that is typically purchased for cars, trucks, motorcycles, and other vehicles, and that is typically used to provide financial protection against physical damage and/or bodily injury resulting from collisions and their associated legal liability (collision coverage) and against loss caused by theft of the covered vehicle or damage to the covered vehicle caused by incidents other than collisions (comprehensive coverage). In addition to the comprehensive and collision coverages, most insurers also offer optional rental reimbursement coverage, also known as rental coverage, that helps pay the insured's rental vehicle costs while their covered vehicle is being repaired as a result of a claim covered under the collision or comprehensive portions of the policy.

Conventionally, insurers sell rental reimbursement coverage according to a dollar-per-day limit combined with a total cost per incident limit. For example, as shown in Table 1, an insurer may offer several levels of dollar-denominated coverage limits at various premium prices. While purchasing vehicle insurance, an insurance customer may consult Table 1 and choose any of the offered rental coverages, perhaps with guidance from an insurance agent.

TABLE 1

| Coverage Limit | Bi-Yearly Premium |
|---|---|
| $15 per day/$450 max per incident | $7.00 |
| $20 per day/$600 max per incident | $8.00 |
| $30 per day/$900 max per incident | $14.00 |
| $40 per day/$1200 max per incident | $16.00 |
| $50 per day/$1500 max per incident | $23.00 |

For instance, as shown in the first row of Table 1, if a customer chooses the rental coverage associated with the $7 premium in order to save money, and the customer later makes a claim because the insured vehicle is unavailable for use (e.g., while being repaired after a collision), then the insurer will pay the customer up to $15 per day to rent a replacement vehicle, limited to $450 in total payments (i.e., limited to 30 days at up to $15 per day). Similarly, as shown in the last row of Table 1, if a customer decides to purchase the rental reimbursement coverage associated with the $23 premium, then in the event of a covered claim, the insurer will pay the customer up to $50 per day to rent a replacement vehicle, limited to $1500 in total payments (i.e., limited to 30 days at up to $50 per day).

Instead of allowing a customer to choose from several levels of dollar-limit-denominated rental coverage when purchasing a vehicle policy, some insurance companies automatically include an insurer-chosen, dollar-limit-based level of rental coverage in the base policy, such as $20 per day/$600 per incident, and the premium for this coverage may be wrapped into a premium for one of the other basic vehicle policy coverages, such as collision coverage.

Conventional dollar-limit-based rental coverage, as exemplified in Table 1, often leads to customer dissatisfaction at the point of claim. Some customers have too little coverage to rent the vehicle they desire, such as a vehicle that is comparable to the insured or covered vehicle (e.g., enough coverage to rent a minivan, where the insured vehicle is a minivan), because the customer purchased a dollar-limit coverage not realizing that it was too low to provide a like-kind-and-quality vehicle. Some customers purchase an adequate dollar-limit rental coverage to begin with, and then simply renew that same coverage year after year without updating the dollar limits to account for price increases in the rental car industry. At claim time, such customers discover, contrary to their expectations, that they have too little coverage to rent the vehicle they desire, such as a like-kind-and-quality vehicle. Customers who did not purchase enough rental coverage also are dissatisfied because they incur out-of-pocket expenses to cover the price difference of renting the vehicle they desire, or because they must accept a rental vehicle that is smaller, of lower quality, or otherwise not comparable to the disabled, covered vehicle in order to stay within their coverage limits.

To avoid this customer dissatisfaction, an insurer may occasionally waive the customer's out-of-pocket expenses above the dollar-denominated coverage limit for renting a vehicle that is of like-kind-and-quality to the insured vehicle. This practice, however, introduces the drawback of rate inadequacy for the insurer because the premium rates charged for rental coverage do not accurately correlate to the actual rental coverage payout severity. If widespread, in the long run, this practice may become a severe problem for the insurer.

Another drawback of conventional dollar-limit-based rental coverage is that it enables customers to unwittingly purchase more coverage than they need or desire. As there is no tie between the dollar limits of conventional rental coverage and the kind or type or class of vehicle that may be rented for a specific amount of dollars, a customer may easily and unintentionally purchase a limit greater than what is needed to rent a like-kind-and-quality vehicle or greater than whatever kind of vehicle the customer desires. This results in dissatisfaction when the customer is given a like-kind-and-quality rental vehicle that does not exhaust the full amount of the dollar limit coverage purchased, or when the customer rents a better vehicle that uses up the coverage limit and realizes that they have been paying higher premiums to cover a rental vehicle that is beyond what they need or desire.

The present disclosure provides several novel improvements to current rental reimbursement insurance systems, methods, and products, including improvements that address the drawbacks of conventional rental insurance and make choosing and maintaining an appropriate level of rental coverage easier, more structured, more efficient, and more closely tied to a customer's needs and desires with respect to a replacement rental vehicle.

### BRIEF DESCRIPTION OF THE DRAWINGS

The accompanying drawings, which are incorporated in and constitute a part of this specification, illustrate embodiments of the invention and together with the description, serve to explain the principles of the invention. Wherever convenient, the same reference numbers have been used to refer to the same or similar components. In the figures:

FIG. 1A is a block diagram of an exemplary system for managing vehicle rental insurance, consistent with embodiments of the invention;

FIG. 1B illustrates an exemplary table of premiums by rental vehicle class, consistent with embodiments of the invention;

FIG. 2 is a block diagram of exemplary techniques for mapping a covered vehicle to a comparable or corresponding rental vehicle class, consistent with embodiments of the invention;

FIG. 3 is an exemplary flow chart for managing rental reimbursement coverage, consistent with embodiments of the invention;

FIG. 4 is a depiction of an exemplary user interface for managing rental insurance transactions, consistent with embodiments of the invention; and

FIG. 5 is a block diagram of an exemplary computing system or data processing system that may be used to implement embodiments consistent with the invention.

### DESCRIPTION OF EMBODIMENTS

In general, embodiments consistent with the present disclosure provide systems, methods, and products that offer, characterize, price, and/or sell rental coverage in terms of the type of vehicle, class of vehicle, or exact vehicle that the customer will obtain as a rental, instead of, or in addition to, a dollar limit per day and/or a dollar limit per incident. Various embodiments consistent with the invention allow insurers to offer, and consumers to choose and pay for, at the time of insurance purchase, the type of vehicle, class of vehicle, and/or exact vehicle they desire as a rental replacement under their rental coverage, which is not possible using conventional dollar-limit-per-day coverage. Various embodiments consistent with the invention also enable customers to obtain at the point of claim a like-kind-and-quality rental vehicle that is comparable to the insured or covered vehicle, which is a result that is not easily achieved, and often not achieved, by conventional dollar-limit-per-day coverage. Other embodiments enable insurers to include and price like-kind-and-quality vehicle rental coverage wrapped into a base coverage or base policy for an insured vehicle.

Various embodiments consistent with the invention may increase customer satisfaction at the point of claim because the coverage (e.g., the effective dollar limits of the insurance) purchased by the customer at the point of sale is consistent with the kind or type of rental vehicle that the customer later receives (i.e., is able to rent with the claim money) at the point of claim—i.e., the customer's coverage corresponds to the type of vehicle expected. Moreover, various embodiments compute a current premium corresponding to each vehicle type, taking into account at least the current prices in the rental car industry for such vehicles, which reduces payout severity risk for the insurer.

Still other embodiments consistent with the invention identify a like-kind-and-quality class of rental vehicle that is comparable to the vehicle of a third-party claimant that was damaged by a covered customer of an insurer. This allows the insurer to approve the rental of a fair and satisfactory replacement vehicle for the third-party claimant.

Yet other embodiments consistent with the invention identify a like-kind-and-quality class of rental vehicle that is comparable to the vehicle covered by a first insurer, which vehicle was damaged by a third-party who is covered by a second, different insurer. When, through subrogation, the first insurer, after paying the rental costs for their insured, seeks to recover the amount of the rental costs from the second insurer, such embodiments enable the first insurer to justify the rental cost as being the cost of a fair and satisfactory replacement vehicle for the damaged, covered vehicle.

Although the descriptions in this disclosure often use a car or an automobile as an example of a vehicle, embodiments consistent with invention are not limited to cars or automobiles and are equally applicable to any other type of vehicle, such as a truck, SUV, cross-over vehicle, mobile home, trailer, motorcycle, watercraft, aircraft, etc.

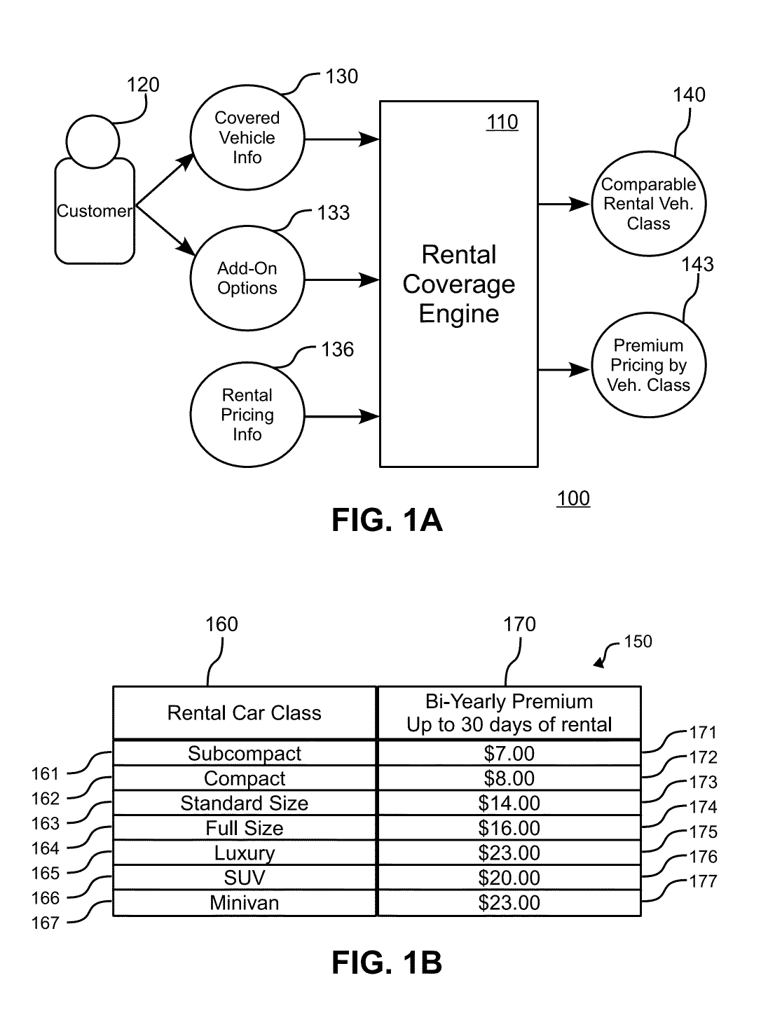

FIG. 1A is a block diagram of an exemplary system 100 for managing vehicle rental insurance, consistent with embodiments of the invention. In the embodiment shown, a rental coverage engine 110 receives input information 130-136 and generates output data 140 and 143. In various embodiments, the rental coverage engine 110 may be implemented in hardware, software, or firmware, including implementation as a computer program or computer application that processes inputs 130-136 to identify a comparable rental vehicle class 140 and/or to compute pricing data for insurance premiums according to vehicle class. In some implementations, the computer program may be executed by a computing system, such as a server computer, which may also implement other parts of a larger vehicle insurance management system.

In the embodiment shown, the covered vehicle info 130 that is input to the rental coverage engine 110 may comprise information that describes one or more characteristics about an automobile that is covered by insurance (i.e., that is already insured), an auto that is in the process of being covered by insurance (i.e., for which the owner is applying for insurance), an auto that was involved in a collision or other accident with an insured auto (i.e., the auto of a third-party claimant), or the like. In various embodiments, the covered vehicle info 130 may include information that describes the vehicle, such as manufacturer-designated characteristics of an automobile, e.g., the vehicle identification number (VIN), make, model, trim line, model year, and the like. The covered vehicle info 130 may also include after-market device or subscription based information associated with the vehicle, such as IP address, SIM card serial number, OnStar™ account number, telematics device serial number, navigation system (e.g., GPS) information, satellite radio receiver and/or subscription information, information relating to child safety seats installed, etc. The covered vehicle info 130 may also include information about the environment of the vehicle, such as where it is primarily operated, who operates it, etc.

As shown in FIG. 1A, all or a portion of the covered vehicle info 130 may be received from or provided by a customer 120, such as a person who owns the covered automobile. In other embodiments, all or a portion of the covered vehicle info 130 may come from another source, such as another insurer with a subrogation claim, a third party information provider, or an insurer database. For example, an insurance agent may collect information identifying the customer 120, and then use a third party database, a third party service or vendor, or the insurer's own records or database (if the customer 120 is a current insured) to look up the covered vehicle info 130 associated with the customer 120.

In the embodiment shown, the add-on option info 133 that is input to the rental coverage engine 110 may comprise information that describes one or more optional car rental products or services that the customer 120 may choose to add to or include with a rental vehicle. Examples of optional add-ons include GPS navigation systems, satellite radio service, one or more child safety seats, rental-company-provided roadside safety service, hybrid engine, duration of rental reimbursement coverage, and the like. In usage, the customer 120 may specify certain add-on features, for example satellite radio service and two child safety seats, that they want in a rental car should their own car (e.g., the covered vehicle) be out of service due to a collision or other incident covered by their auto insurance. The chosen add-on features may replicate the features of the customer's 120 insured vehicle, or they may simply be features that the customer 120 desires in a rental vehicle and for which they are willing to pay a higher premium.

The rental pricing info 136 may comprise information that describes the price or prices charged by one or more vehicle rental companies (e.g., rental car companies) to rent various vehicles (e.g., various automobiles). The rental pricing info 136 may also include information that describes the prices charged by rental companies for optional add-ons, such as GPS navigations systems, satellite radio, and child safety seats. In various embodiments, rental pricing info 136 may be provided by one or more vehicle rental companies (such as the Avis™, Hertz™, Enterpriser™, etc., car rental companies), or it may be gathered by, or on behalf of, a vehicle insurer for use by the rental coverage engine 110. In some embodiments, some or all of the rental pricing info 136 may be gathered by the rental coverage engine 110, or associated computerized systems, from the web sites or web applications of vehicle rental companies. In some embodiments, the rental pricing info 136 may be organized according to vehicle class. In other embodiments, the rental pricing info 136 may be organized by vehicle, and the rental coverage engine may process the per vehicle information to place each vehicle into one of several vehicle classes.

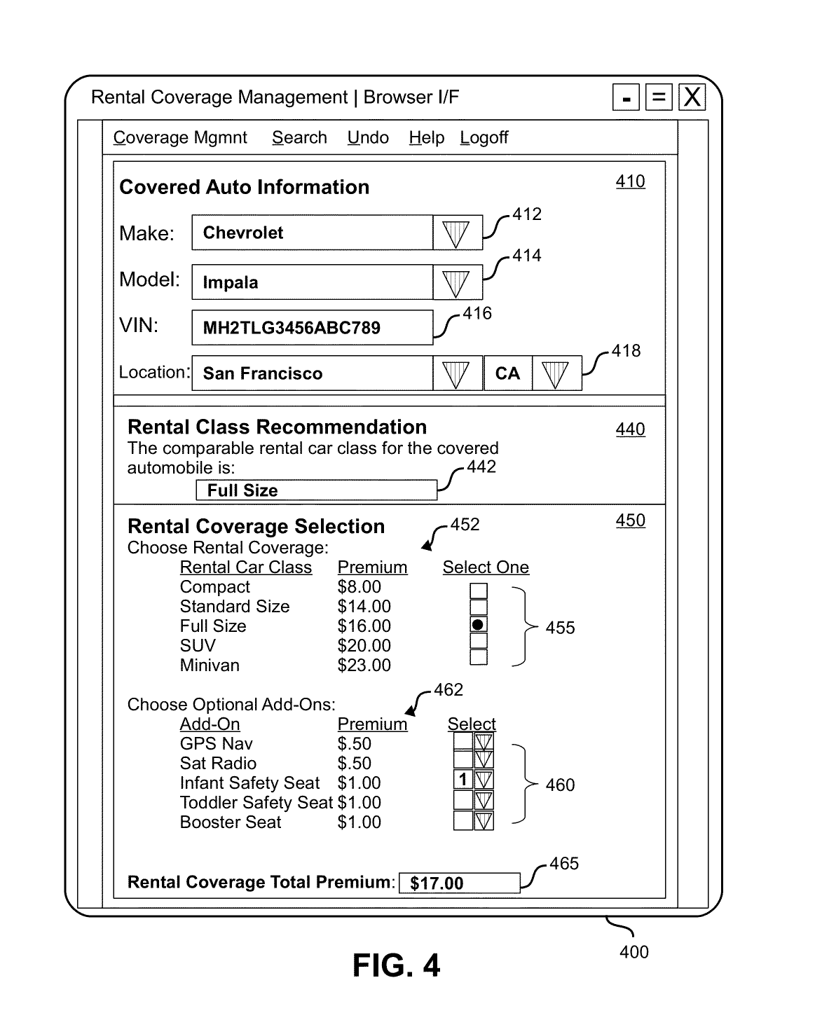

The rental coverage engine 110 may process the covered vehicle info 130 to produce the comparable rental vehicle class 140, which may be output or presented to the customer 120 and/or an insurance agent working with the customer 120, by, for example, displaying the comparable rental vehicle class 140 on a user interface of a computing system (e.g., as shown in FIG. 4), or by printing the comparable rental vehicle class 140 using a printer connected, either physically or wirelessly, to a computing system.

In some embodiments, the rental coverage engine 110 may map the covered vehicle into one class among a set of predefined (e.g., insurer-defined) rental vehicle classes based on the characteristics of the covered vehicle, as represented in the covered vehicle info 130. In various embodiments, the set of predefined rental vehicle classes represents the types of vehicles for which an insurer offers rental reimbursement coverage. One example of a set of predefined vehicle classes is: subcompact car; compact car; standard size car; full size car; luxury car; SUV; and minivan.

Thus, for example, the rental coverage engine 110 may identify specific data among the covered vehicle info 130, such as data identifying the manufacturer and model name of the covered vehicle, and use that data to appropriately choose, map to, or identify and output the comparable rental vehicle class 140. For instance, if the covered vehicle info 130 includes data identifying the vehicle manufacturer as “Ford” and the model name as “Fusion,” then the rental coverage engine 110 may use that data to map to the “standard size” rental car class. For another example, if the covered vehicle info 130 includes data identifying the vehicle manufacturer as “Honda” and the model name as “Odyssey,” then the rental coverage engine 110 may use that data to map to the “minivan” rental car class. In some embodiments, the rental coverage engine 110 may use specific data from the covered vehicle info 130 to find a corresponding car class entry in a database or data structure, such as a look up table, organized according to rental car class, manufacturer, and/or model name.

The rental coverage engine 110 may process the rental pricing info 136 to produce the premium pricing by vehicle class 143. In some embodiments, the rental coverage engine 110 may calculate a premium for each vehicle class based on the cost of renting a vehicle in that class, as represented in the rental pricing info 136. In some embodiments, the rental pricing info 136 may be processed before it is used to compute premiums. For example, the rental coverage engine 110 may use the pricing information from two or more rental car companies and compute an average, median, 75^{th} percentile, or other representation of rental pricing for each rental vehicle class.

Based on the raw or preprocessed rental pricing info 136, the rental coverage engine 110 may calculate premiums for each rental car class using techniques known in the art that take into account the frequency of claims, cost of claims, number of insureds, risk appetite of the insurer, and other factors known in the art.

In various embodiments, the premium calculation may also take into account geographical differences in rental pricing. For example, car rental prices, and therefore premiums for rental coverage, may be higher in San Francisco, Calif. than in Hartford, Conn. In some embodiments, the premiums may be calculated based on regional or national rental pricing info 136 (for example, calculated based on an average of many price points from locations throughout the country, for each rental car class), such that the premium pricing by vehicle class 143 does not directly reflect local geographical differences in rental industry pricing. In such implementations, in expensive geographic regions, the customer may in effect receive more coverage than the premium would ordinarily pay for, similar to a claim manager waiving out-of-pocket rental costs for a customer at the point of claim.

In various embodiments, the rental coverage engine 110 may calculate the premium pricing by vehicle class 143 periodically (e.g., annually or more or less often) to accurately reflect any recent changes in the rental pricing info 136, or other factors, and store the current premiums for use until the next periodic recalculation. In various embodiments, the premium pricing by vehicle class 143 may be calculated independently of the comparable rental vehicle class 140 that is calculated for a specific customer 120, and in other embodiments, the premium pricing by vehicle class 143 may be calculated in conjunction with the comparable rental vehicle class 140 calculated for each customer 120 that uses rental coverage engine 110.

In various embodiments, the rental coverage engine 110 may output or present the premium pricing by vehicle class data 143 to the customer 120 and/or an insurance agent working with the customer 120, by, for example, displaying the premium pricing by vehicle class 143 on a user interface of a computing system (see, for example, FIG. 4), or by printing the premium pricing by vehicle class 143 using a printer connected to a computing system.

FIG. 1B illustrates an exemplary table 150 of premiums by vehicle class. In some embodiments, the premium pricing by vehicle class 143 that is output by the rental coverage engine 110 may be organized and/or presented as shown in table 150. In the embodiment shown, table 150 includes a “Rental Car Class” column 160 and a “Bi-Yearly Premium” column 170. As shown, each row of the Rental Car Class column 160 of table 150 includes a type or class of car that the rental reimbursement insurance will cover, such as a subcompact class 161, a compact class 162, a standard size class 163, a full size class 164, a luxury class 165, an SUV (sport utility vehicle) class 166, and a minivan class 167. In various embodiments, an insurer may define and use more, fewer, and/or different rental vehicle classes than those shown in FIG. 1B.

Each row of the Bi-Yearly Premium column 170 indicates a premium for rental reimbursement coverage to rent, for up to 30 days, the class of car shown in the same row of column 160. For example, a premium 171 of $7.00 is charged for coverage sufficient to rent a subcompact car 161; a premium 172 of $8.00 is charged for coverage sufficient to rent a compact car 162; a premium 177 of $23.00 is charged for coverage sufficient to rent a minivan 167, etc. As noted above rental coverage engine 110 may calculate (e.g., by using a look-up table), the prices in Bi-Yearly Premium column 170, which prices may be based on rental pricing info 136 and other factors and information.

In various embodiments, an insurer may define and/or present the premiums for coverage limits and durations different than the “up to 30 days rental” coverage limit and “bi-yearly” (6 month) duration shown in FIG. 1B.

One of ordinary skill in the art will recognize that elements may be added to, removed from, or modified within system 100 and table 150 without departing from the principles of the invention. For example, systems consistent with the invention may include other input information, such as rental coverage claim histories or experience, for use by rental coverage engine 110 in calculating or adjusting premium pricing. Similarly, systems consistent with the invention may receive input information from sources that are not shown, for example, as described herein, covered vehicle info 130 may come from one or more sources other than customer 120. For another example with respect to embodiments that are used to find a comparable rental vehicle for a third-party claimant or for a subrogration claim, rental coverage engine 110 may not provide the premium pricing by vehicle class output 143.

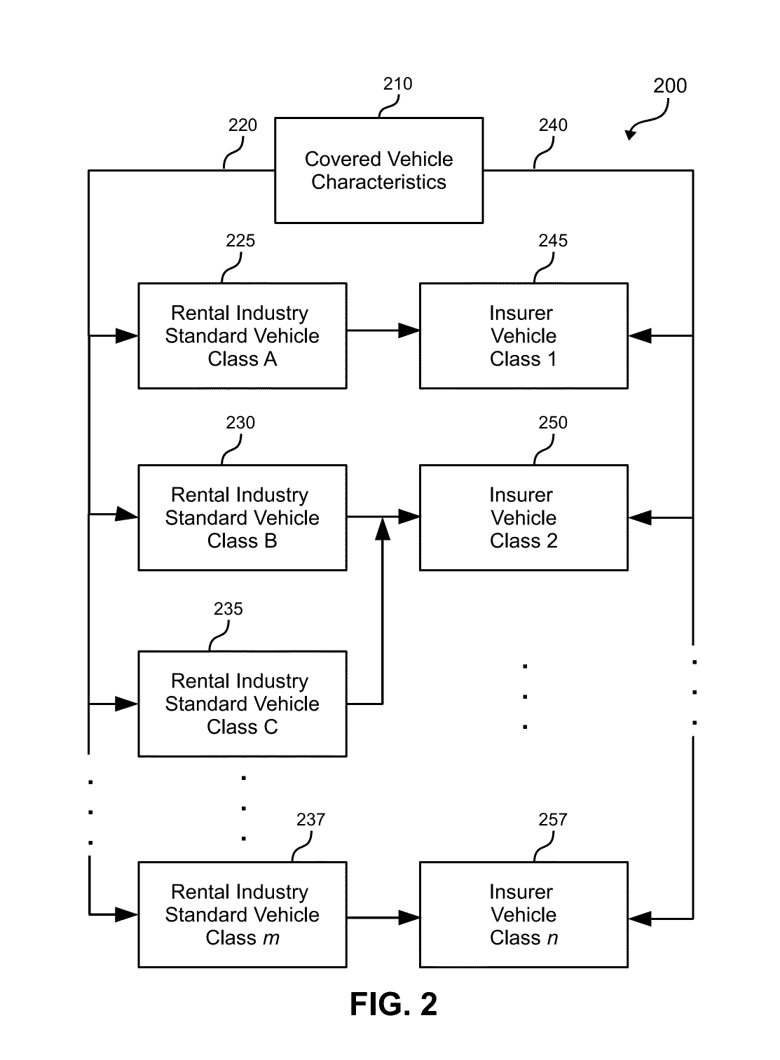

FIG. 2 is a block diagram 200 of exemplary techniques for mapping a covered vehicle to a comparable or corresponding rental vehicle class, consistent with embodiments of the invention. In various embodiments, the techniques shown in FIG. 2 may be implemented in hardware, software, or firmware. For example, the technique of FIG. 2 may be implemented by a computing system, such as a server computer, executing a software application or applications, as part of a vehicle insurance management system.

As shown in FIG. 2, a set of covered vehicle characteristics 210, e.g., data describing the characteristics of an insured or covered vehicle, may be mapped directly 240 or indirectly 220 to an insurer rental vehicle class 245-257. Similar to what was noted previously with respect to the covered vehicle info 130, various embodiments of the covered vehicle characteristics 210 may include the vehicle's VIN, manufacturer, model, trim line, and the like. In some embodiments, the covered vehicle characteristics 210 may include information classifying the vehicle into one of a set of proprietary classes derived by an insurance company based, for example, on data such as the vehicle's VIN, manufacturer, model, trim line, Insurance Services Office (ISO) class, and the like, in conjunction with the insurance company's claim history data and/or loss data. For example, an insurance company may define a set of set of proprietary classes (e.g., a set of loss groups) classified or defined by any relevant loss characteristic(s), for example, severity of losses, frequency of losses, type of losses, etc., and associate or aggregate specific vehicles within each class, where the vehicles are described or characterized according to VIN, manufacturer, model, trim line, and the like. In such embodiments, the proprietary class that a vehicle belongs to may affect the premium pricing for rental coverage associated with that vehicle. For instance, vehicles that are categorized into a proprietary class associated with more frequent and/or more severe losses may have a higher premium for rental coverage.

In embodiments that use direct mapping 240, a process or system implementing techniques 200 may map or categorize the covered vehicle characteristics 210 of the insured vehicle into one of a set of insurer-defined rental vehicle classes 1 . . . n 245-257. An example of a set of insurer-defined rental vehicle classes 1 . . . n is shown in column 160 of table 150 in FIG. 1B. In various embodiments, this mapping or categorizing may be done as described previously with respect to FIG. 1A, where the insurer-defined rental vehicle class 245-257 that the covered vehicle characteristics 210 map to is output as the comparable rental vehicle class 140 of FIG. 1A.

In embodiments that use indirect mapping 220, a process or system implementing techniques 200 may first map or categorize the covered vehicle characteristics 210 of the insured vehicle into one of a set of several rental industry standard vehicle classifications A . . . m 225-237. The rental industry standard vehicle classifications 225-237 may include, but are not limited to, any one of, or any combination of, vehicle categories associated with a class code from a third party associated with the automobile and/or vehicle rental industries, for example, a standards organization (such as ISO or ACRISS), a rental car company, or the like.

As shown, the rental industry standard vehicle classifications 225-237 may themselves be mapped to the set of insurer-defined rental vehicle classes 1 . . . n 245-257. Thus, a covered vehicle that corresponds to a particular one of the set of rental industry standard vehicle classifications A . . . m 225-237, also corresponds to the insurer-defined rental vehicle class to which that particular rental industry standard vehicle classification maps. For example, if the covered vehicle characteristics 210 of an insured vehicle map to the rental industry standard vehicle class A 225, then the insured vehicle also maps to the insurer rental vehicle class 1 245, as represented by the arrows in FIG. 2.

As shown in FIG. 2 with respect to the rental industry standard vehicle class B 230, the rental industry standard vehicle class C 235, and the insurer rental vehicle class 2 250, there is not necessarily a one-to-one correlation between the rental industry standard vehicle classes A . . . m 225-237 and the insurer's rental vehicle classes 1 . . . n 245-257. For example, if the covered vehicle characteristics 210 of an insured vehicle map to the rental industry standard vehicle class B 230, or to the rental industry standard vehicle class C 235, then the insured vehicle also maps to the insurer rental vehicle class 2 250, as represented by the arrows in FIG. 2.

One of ordinary skill in the art will recognize that features may be added to, deleted from, or modified within techniques 200 without departing from the scope of the invention. For example, the rental industry standard vehicle classes A . . . m 225-237 could be employed as-is by the insurer, eliminating the use of the insurer rental vehicle classes 1 . . . n 245-257.

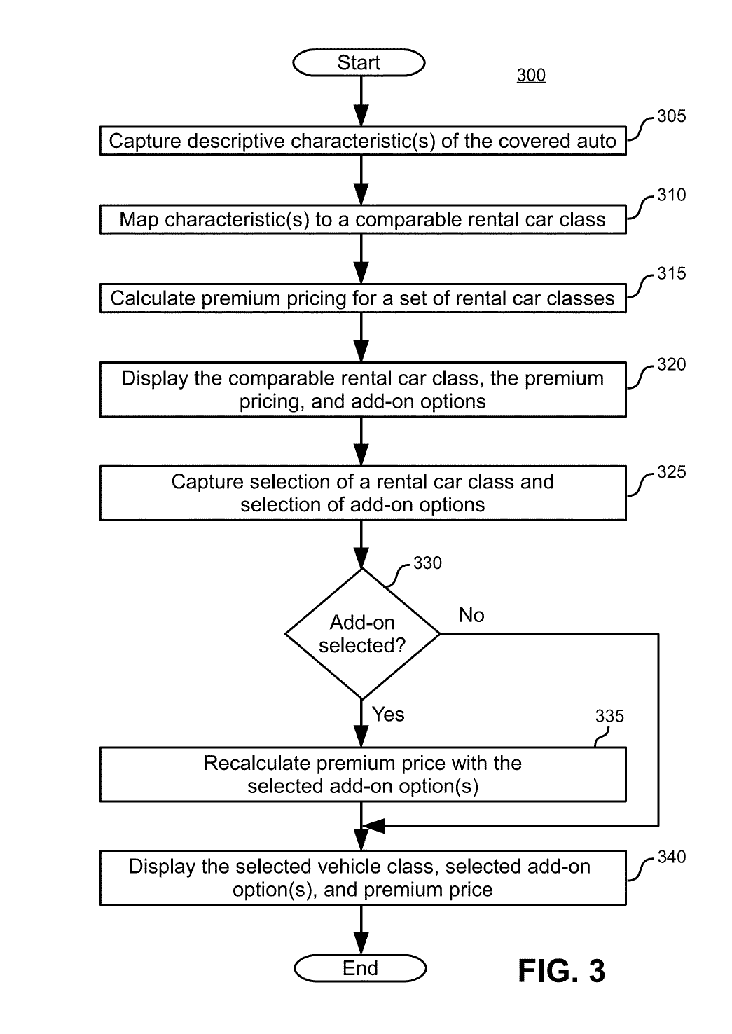

FIG. 3 is an exemplary flow chart 300 for managing rental reimbursement coverage. In various embodiments, flow chart 300 may be implemented in hardware, software, or firmware. For example, flow chart 300 may be implemented by a server computer executing a software application or applications, which interact with clients, such a web browser executing on a remote computer.

As shown in FIG. 3, flow chart 300 begins with capturing descriptive characteristic(s) of a covered auto (block 305). In various embodiments, the one or more descriptive characteristics may be captured when a user, such as a customer 120 or an insurance agent working with a customer, types or otherwise inputs them into a user interface or otherwise provides them to a software application or system implementing flow chart 300. In some embodiments, the descriptive characteristics of the covered auto may be received from another computer system or a database in which they were previously stored.

In various embodiments, a covered auto may include, but is not limited to, any auto involved in an insurance related transaction that involves rental coverage, including, for example, 1) a transaction to create a quote or to issue auto coverage through an insurance company's proprietary system or a third-party system such as, but not limited to: a comparative rater, an agency management system, a web-based quote aggregator, or the like; 2) a transaction for renewal of existing auto coverage with an insurance company; 3) a transaction related to disablement of a third party's car due to accident with an insured auto (e.g., a third-party claimant); or 4) a subrogation transaction related to seeking to recover the amount of a rental claim loss from another insurer that is liable for the claim, among other transactions.

Block 310 of the flowchart maps the descriptive characteristic(s) of the covered auto to a comparable rental car class. In various embodiments, as described previously, a set of vehicle classes may be defined by the insurer (as shown, for example, in column 160 of FIG. 1B), and the covered auto is correlated with the vehicle class in the set that most appropriately or most closely matches or describes the covered auto. For example, if the descriptive characteristic(s) of the covered auto indicate that it is a luxury sedan, block 310 may map those characteristic(s) to a luxury car class, such as is shown in row 165 of column 160 in FIG. 1B. As noted previously, in some embodiments, the rental car classes may be proprietary classes defined by the insurer according to loss characteristics associated with an automobile.

In some embodiments, mapping the covered auto to a comparable rental car class includes a two-phase, indirect mapping first to an industry standard category and then the standard category is mapped to one of the insurer's rental car classes, as explained with respect to FIG. 2. In other embodiments, the covered auto may be mapped directly to the corresponding insurer-defined rental car class.

Block 315 of flowchart 300 calculates premium pricing for the set of rental car classes. As explained previously, and as shown in FIG. 1B, the insurer calculates a premium (column 170) to charge for rental coverage that allows rental of a car in each rental car class (column 160). In various embodiments, because the premium for each rental car class is based on rental pricing information 136 that reflects the current prices being charged in the market by car rental companies, the insurer is able to offer premiums that can reasonably be expected to cover both the expected cost of losses and the cost of issuing and administering the policy.

At block 320, flowchart 300 displays the comparable rental car class to which the covered auto mapped in block 310, the premium pricing calculated in block 315, and the add-on options that are available as part of the rental coverage for an additional premium.

Block 325 captures the customer's choice of rental car class and add-on option selections, if any. In various embodiments, the chosen rental car class and add-on options may be captured when a user, such as a customer 120 or an insurance agent working with a customer, types them into a user interface (e.g., as shown in FIG. 4), engages a control on a user interface, or otherwise provides them to a software application or system implementing flowchart 300. For example, the customer may activate a check box control that is displayed next to a “compact” rental car class in order to indicate their choice of rental coverage sufficient to rent a compact car, and may type the number “1” into a text box control that is displayed next to an “infant safety seat” option in order to indicate their choice of renting a single infant car seat with the compact car. In some embodiments, the customer's choice of rental car class and add-on options may be received from another computer system or a database in which they were previously stored.

In various embodiments, the customer may choose as their desired car class for rental coverage the comparable rental car class determined in block 310, or they may choose a different rental car class from among the set of rental car classes offered by the insurer. Consequently, the customer can easily determine and purchase enough coverage to be able to rent the kind of car they want, whether it be a car that is comparable (e.g., in the same class) as their own car, or a car that is in a more expensive, or less expensive, or otherwise different class. Unlike a conventional dollar-per-day delimited rental coverage system, the potential for a mismatch between the customer's expectations and the type of rental car their purchased coverage actually encompasses may be greatly reduced or eliminated.

Block 330 determines whether the customer selected any of the add-on options displayed in block 320 and captured in block 325. If the customer did not select, choose, or enter any add-on options (block 330, No), then processing proceeds to block 340, as described below. If, on the other hand, the customer selected an add-on option(s) (block 330, Yes), then processing proceeds to block 335.

Block 335 of flowchart 300 recalculates the premium pricing for the customer-selected rental car class and the customer-selected add-on options. In general, the price of the premium will increase for each selected add-on option, reflecting the increased rental fee charged by rental companies for the add-on option. In various embodiments, as with the premium calculated for each rental car class in block 315, the recalculation may be based on rental pricing information 136 that reflects the current prices being charged in the market by car rental companies for the add-on option(s) selected by the customer.

In block 340, the selected vehicle class, any selected add-on options, and the premium pricing, (which may be the recalculated premium pricing if block 335 was executed) are displayed. In various embodiments, block 340 may provide feedback and confirmation to a customer 120, or the customer's agent, regarding the rental coverage that the customer has chosen and the premium for this coverage. One possible example of a display generated by flowchart 300 at block 340 is shown in FIG. 4.

One of ordinary skill in the art will recognize that blocks may be added to, deleted from, modified, or reordered in flow chart 300 without departing from the scope of the invention. For example, block 315 may be removed from flowchart 300 and performed independently of the blocks in flowchart 300. For another example, blocks 305 and 325 could be combined into a single block so that the user-entered information is all received at the same time, and consequently blocks 330 and 335 may be deleted as unnecessary. For yet another example, a block could be added (e.g., before block 315) to capture a user's selection of a duration of rental coverage, such as seven days, 15 days, 30 days, or longer, and block 315 may be modified to calculate or adjust the premium pricing according to the duration selected by the user. For instance, the premium for seven days of rental reimbursement coverage would be less than the premium for 30 days of rental reimbursement coverage, given the same class of vehicle for both coverages. In other embodiments, different durations of rental reimbursement coverages may be displayed as optional add-ons and captured in blocks 320 and 325, and the premium may be recalculated to take into account the selected duration in block 335.

FIG. 4 is a depiction of an exemplary user interface 400 for managing rental insurance transactions, consistent with embodiments of the invention. In various embodiments, the user interface 400 may be generated by hardware, software, or firmware. For example, the user interface 400 may be generated by a computing system, such as a server computer, executing a software application or applications, such as the rental coverage engine 110, as part of an automobile policy management system. For another example, user interface 400 may be generated by the browser on a client computer used by a customer 120, or an insurance agent working with a customer, that is in communication with a server maintained by an insurance company, which server may be running the rental coverage engine 110.

Vehicle rental insurance management systems and processes that utilize an interface such as user interface 400 of FIG. 4 may be employed for various types of transactions. For example, such systems and processes may be utilized for new business transactions, providing the advantage that rental expectations are set at point of sale when the customer selects a rental vehicle class and optionally selects add-ons such as GPS and child car seats. Such systems and processes may also be utilized on renewal business transactions, providing the advantage that the underlying rental limits for each class are up-to-date and sufficient to provide a like-kind-and-quality vehicle and any add-ons currently needed by the customer regardless of rental pricing changes in the rental car industry. In rental coverage renewal transactions, the rental-vehicle-class product may in effect provide automated rental limit inflation, as the rental vehicle classes and premiums are tied directly to the current rental vehicle market prices.

Systems and processes that employ an interface similar to user interface 400 of FIG. 4 may also be utilized for third party claim transactions and subrogation transactions, providing an automated rental vehicle class determination that is easier to generate, more efficient, and much more consistent than the conventional technique of assigning a rental vehicle to a third-party claimant or insured according to the claim adjuster's experience and expertise. In addition, third-party claimants may also be offered add-on options to match the features of their damaged add-ons such as GPS navigation and child safety seats.

The embodiment of the user interface 400 shown in FIG. 4 is divided into three sections: a covered auto section 410, a comparable class recommendation section 440, and a rental coverage selection section 450.

The covered auto section 410 prompts the user for, and receives or captures, information or one or more characteristics that describe the automobile that a customer wishes to, or has previously, insured. In the embodiment shown, the covered auto section 410 uses text to prompt the user to enter the make (i.e., manufacturer) of the insured auto, and provides a drop down menu 412 to capture or receive this information from the user. Similarly, the covered auto section 410 prompts the user to enter the model name of the insured auto and the primary location of the insured auto, and provides drop down menus 414 and 418, respectively, to capture this information. The covered auto section 410 also allows the user to type into text box 416 the VIN of the covered automobile. In the example shown in FIG. 4, a user has entered a 2010 Chevrolet Impala located in San Francisco, Calif. with the VIN shown as the covered automobile.

In some embodiments, a section (not shown) similar to the covered auto section 410 may be added to, or substituted into, the user interface 400, where the similar section may be used to enter information describing the auto of a third-party claimant, so that the system may generate a recommendation for a comparable rental class that the insurer will pay for while the third-party claimant's auto is out of service.

The rental class recommendation section 440 outputs a comparable rental car class 442 which is computed by the underlying system based on the information and characteristics describing the covered auto, as specified in the covered auto section 410. In various embodiments, the comparable rental car class 442 may be equivalent to the comparable rental vehicle class 140 calculated by the rental coverage engine, as described with respect to FIGS. 1A and 2. In the example shown in FIG. 4, the system has calculated that the rental car class “Full Size,” as displayed at 442, is of like-kind-and-quality to a 2010 Chevrolet Impala, as specified in the covered auto section 410. In some embodiments, the recommendation of the comparable rental car class 442 may be provided to another insurer, as part of a subrogation process, to demonstrate that the rental coverage loss for which recovery is sought corresponds to a like-kind-and-quality vehicle in comparison to the covered vehicle.

The rental coverage selection section 450 of user interface 400 captures or receives the user's choices or selections regarding the rental coverage that the user wishes to purchase, and displays the price of the insurance premium for the selected rental coverage. In various embodiments, the premiums for the rental car classes may be computed each time the underlying system that generates the user interface 400 is invoked, using the latest data from the car rental industry, such as rental pricing data 136. In other embodiments, the prices of the premiums for the rental car classes have been computed previously and stored for use by the underlying system. In both types of embodiments, in various implementations, the prices may be initially calculated, or later adjusted, to take into account the local geographical differences in rental industry pricing and generate premiums that correspond to the location 418 of the covered auto.

As shown in the embodiment of FIG. 4, the rental coverage selection section 450 displays a list 452 of the rental car classes that are covered by the insurer and the associated base premiums, alongside a set of corresponding radio buttons 455 that allow a user to input their choice of coverage. In various embodiments, a user may be allowed to select coverage for any class of rental car desired, which may or may not match the comparable rental car class 442 displayed in the rental class recommendation section 440. In some embodiments, the radio button 455 corresponding to the comparable rental car class 442 displayed in the rental class recommendation section 440 may be activated by default, and the user may be allowed to change this default selection. In other embodiments, the radio button 455 corresponding to the comparable rental car class 442 displayed in the rental class recommendation section 440 may be inactivated, and the user may not be allowed to choose a different base coverage, for example, in an embodiment designed to support a subrogation transaction or a third-party claim transaction. In the example shown in FIG. 4, the user has selected the “Full Size” rental car class, by activating the corresponding radio button 455.

As shown in the example of FIG. 4, the rental coverage selection section 450 also displays a list 462 of the optional rental car add-ons that are covered by the insurer and the associated additional premiums, alongside a set of corresponding drop down menus 460 that allow a user to input their choice(s) (if any) of coverage for the add-ons. In various embodiments, the list 462 of optional add-ons may include more, fewer, and/or different option than those depicted in the example of FIG. 4. For example, the list 462 of optional add-ons may include a variety of types of services or devices that may be added to a rental automobile, such as different types of navigation systems other than GPS, collision avoidance systems, various durations of rental reimbursement coverage, etc. In the example shown in FIG. 4, the user has selected one “Infant Safety Seat” as an add-on option, as indicated by the “1” in the corresponding pull-down menu 460.

The rental coverage selection section 450 also displays the total rental coverage premium 465, which includes any add-ons selected by the user. In various embodiments, the system calculates the total rental coverage premium 465 by adding the base premium for the selected rental car class and any additional premium(s) for any selected add-ons.

One of ordinary skill in the art will recognize that the user interface 400 shown on FIG. 4 is necessarily simplified for conciseness and clarity of explanation, and that information and controls may be added, deleted, modified, rearranged, or presented differently without departing from the scope of the invention. For example, the covered auto information section 410 may be modified to include only text box 416 for the VIN of the covered automobile, and the system may compute a recommended rental car class from the VIN, as the make, model, size, options, etc., of the covered auto may be derived from the VIN. For another example, the covered auto information section 410 and the rental class recommendation section 440 (and the underlying processing and computations that generate them) may be eliminated, so that a customer may select a rental car class for rental coverage (452, 455) without automated mapping of their insured vehicle to a comparable rental class. For yet another example, the underlying system could compute, and the rental coverage section 450 could display, in addition the rental car classes in list 452, the equivalent dollars-per-day coverage for each class.

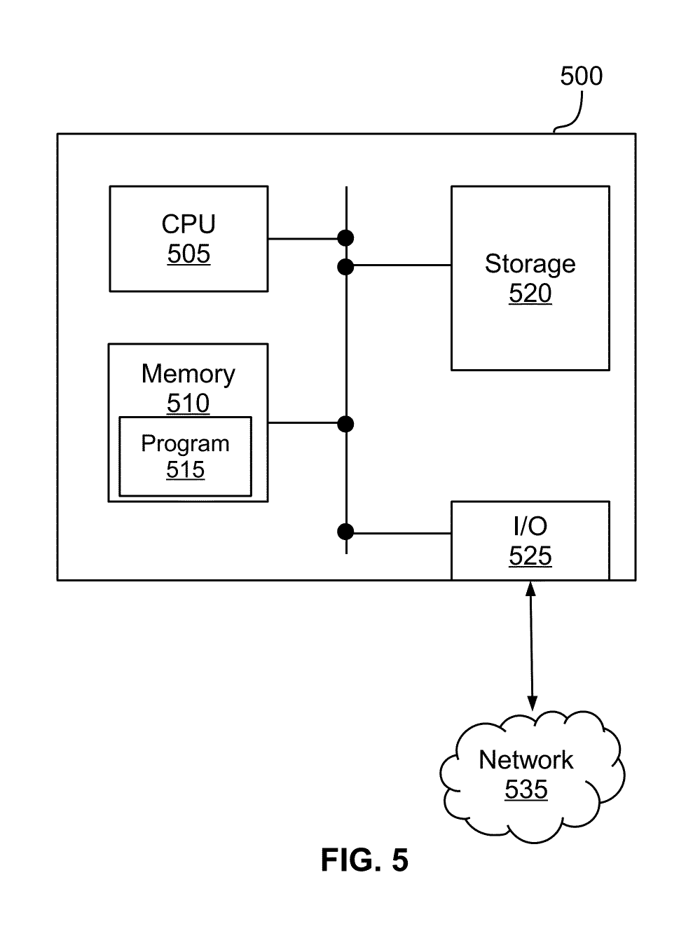

FIG. 5 is a block diagram of an exemplary computing system or data processing system 500 that may be used to implement embodiments consistent with the invention. Other components and/or arrangements may also be used. In some embodiments, computing system 500 may be used to implement a vehicle rental insurance management system, either stand alone or as part of a larger vehicle insurance management system.

Computing system 500 includes a number of components, such as a central processing unit (CPU) 505, a memory 510, an input/output (I/O) device(s) 525, and a nonvolatile storage device 520. System 500 can be implemented in various ways. For example, an implementation as an integrated platform (such as a workstation, server, personal computer, tablet computer, laptop, smart phone, etc.) may comprise CPU 505, memory 510, nonvolatile storage 520, and I/O devices 525. In such a configuration, components 505, 510, 520, and 525 may connect and communicate through a local data bus and may access a database (not shown) (implemented, for example, as a separate database system) via an external I/O connection. I/O component(s) 525 may connect to external devices through a direct communication link (e.g., a hardwired or local wifi connection), through a network, such as a local area network (LAN) or a wide area network (WAN), and/or through other suitable connections. System 500 may be standalone or it may be a subsystem of a larger system.

CPU 505 may be one or more known processing devices, such as a microprocessor from the Core™ 2 family manufactured by the Intel™ Corporation of Santa Clara, Calif. Memory 510 may be one or more fast storage devices configured to store instructions and information used by CPU 505 to perform certain functions, methods, and processes related to embodiments of the present invention. Storage 520 may be a volatile or non-volatile, magnetic, semiconductor, tape, optical, or other type of storage device or computer-readable storage medium, including devices such as CDs and DVDs, meant for long-term storage.

In the illustrated embodiment, memory 510 contains one or more programs or subprograms 515 loaded from storage 520 or from a remote system (not shown) that, when executed by CPU 505, perform various operations, procedures, processes, or methods consistent with the present invention. Alternatively, CPU 505 may execute one or more programs located remotely from system 500. For example, system 500 may access one or more remote programs via network 535 that, when executed, perform functions and processes related to or implementing embodiments of the present invention.

In one embodiment, memory 510 may include a program(s) 515 that implements a vehicle rental insurance management system, such as a program that implements rental coverage engine 110, and/or flowchart 300, and/or user interface 400. In some embodiments, memory 510 may also include other programs or applications that implement other methods and processes that provide ancillary functionality to the invention. For example, memory 510 may include programs that gather from various sources, organize, store, and/or generate rental coverage claim data and rental pricing info 136 used by rental coverage engine 110.

Memory 510 may be also be configured with other programs (not shown) unrelated to the invention and/or an operating system (not shown) that performs several functions well known in the art when executed by CPU 505. By way of example, the operating system may be Microsoft Windows™, Unix™, Linux™, an Apple Computers™ operating system, Personal Digital Assistant operating system such as Microsoft CE™, or other operating system. The choice of operating system, and even to the use of an operating system, is not critical to the invention.

I/O device(s) 525 may comprise one or more input/output devices that allow data to be received and/or transmitted by system 500. For example, I/O device 525 may include one or more input devices, such as a keyboard, touch screen, mouse, and the like, that enable data to be input from a user, such as a customer 120 or an agent working with the customer 120. Further, I/O device 525 may include one or more output devices, such as a display screen, CRT monitor, LCD monitor, plasma display, printer, speaker devices, and the like, that enable data to be output or presented to a user. I/O device 525 may also include one or more digital and/or analog communication input/output devices that allow computing system 500 to communicate, for example, digitally, with other machines and devices. Other configurations and/or numbers of input and/or output devices may be incorporated in I/O device 525.

In the embodiment shown, system 500 is connected to a network 535 (such as the Internet, a private network, a virtual private network, or other network), which may in turn be connected to various systems (e.g., rental car company servers) and computing machines (not shown), such as personal computers, laptop computers, and/or smart phones of users who wish to utilize system 500. In general, system 500 may input data from external machines and devices and output data to external machines and devices via network 535.

A database (not shown) may also be used in conjunction with system 500. In some embodiments, a standalone database external to system 500 may be used. In other embodiments, a database may be hosted by system 500. The database may be used to manage and store data used to implement systems and methods consistent with the invention. For example, a database may manage and store data structures that contain rental coverage claim data, rental pricing info 136, current rental coverage premium data (e.g., as in table 150), and other information used by rental coverage engine 110 and/or flowchart 300. Such a database may store information that is accessed and/or managed through system 500. By way of example, such a database may be an Oracle™ database, a Sybase™ database, or other relational database. Systems and methods consistent with the invention, however, are not limited to separate data structures or databases, or even to the use of a database or data structure.

It will be apparent to those skilled in the art that various modifications and variations can be made to the structures and methodologies described herein. Thus, it should be understood that the invention is not limited to the examples discussed in the specification. Rather, the present invention is intended to cover modifications and variations.

What is claimed is:

1. A method, implemented using a computing system, for managing vehicle rental insurance, the method comprising:
receiving, by the computing system, information describing a vehicle that is covered by vehicle insurance;
receiving, by the computing system, information describing a plurality of vehicle classes;
comparing, using the computing system, the information describing the vehicle that is covered by vehicle insurance to the information describing the plurality of vehicle classes;
categorizing, using the computing system, the vehicle into one vehicle class among the plurality of vehicle classes based on the comparing; and
presenting to a user an indication of the one vehicle class for use in a vehicle rental insurance transaction.

2. The method of claim 1, wherein the plurality of vehicle classes is defined by a standards organization; and
wherein categorizing further comprises mapping the one vehicle class to a vehicle class defined by an insurer associated with the rental insurance.

3. The method of claim 1, further comprising:
receiving, by the computing system, information describing a market rental price for each vehicle class of the plurality of vehicle classes;
calculating, by the computing system, a premium for rental insurance coverage for each vehicle class of the plurality of vehicle classes based on the information describing the market rental price for each vehicle class of the plurality of vehicle classes; and
presenting to the user an indication of a premium, from the plurality of premiums, that corresponds to the one vehicle class.

4. The method of claim 3, wherein receiving information describing the market rental price for each vehicle class of the plurality of vehicle classes comprises:
receiving information describing the market rental prices for a plurality of geographic areas for each vehicle class of the plurality of vehicle classes; and
wherein calculating the premium for rental insurance coverage further comprises:
calculating a premium for rental insurance coverage for at least one geographic area among the plurality of geographic areas for each vehicle class of the plurality of vehicle classes based on the information describing the market rental price for each vehicle class of the plurality of vehicle classes.

5. The method of claim 3, wherein presenting to the user the indication of the one vehicle class for use in the vehicle rental insurance transaction comprises:
presenting to the user an indication of the one vehicle class and the premium corresponding to the one vehicle class for use in the vehicle rental insurance transaction.

6. The method of claim 3, further comprising:
receiving, by the computing system, information describing the market rental prices for a plurality of optional add-ons that are available to rent;
calculating, by the computing system, an add-on premium for rental insurance coverage for each add-on of the plurality of optional add-ons based on the information describing the market rental prices for the plurality of optional add-ons; and
presenting to the user an indication of at least one add-on premium.

7. The method of claim 1, further comprising receiving from the user, by the computing system, an indication of a selection of an alternate vehicle class, different from the one vehicle class.

8. The method of claim 1, further comprising receiving from the user, by the computing system, an indication of a coverage selection.

9. The method of claim 8, wherein the coverage selection comprises at least one of a vehicle class and an optional add-on.

10. The method of claim 1, wherein the vehicle rental insurance transaction comprises at least one of a third-party claimant transaction and a subrogation transaction.

11. An apparatus for managing vehicle rental insurance, the apparatus comprising:
a memory containing instructions; and
a processor, operably connected to the memory, that executes the instructions to perform operations comprising:
receiving information describing a vehicle that is covered by vehicle insurance;
receiving information describing a plurality of vehicle classes;
comparing the information describing the vehicle that is covered by vehicle insurance to the information describing the plurality of vehicle classes;
categorizing the vehicle into one vehicle class among the plurality of vehicle classes based on the comparing; and
presenting to a user an indication of the one vehicle class for use in a vehicle rental insurance transaction.

12. The apparatus of claim 11, wherein the plurality of vehicle classes is defined by a standards organization; and
wherein categorizing further comprises mapping the one vehicle class to a vehicle class defined by an insurer associated with the rental insurance.

13. The apparatus of claim 11, the operations further comprising:
receiving information describing a market rental price for each vehicle class of the plurality of vehicle classes;
calculating a premium for rental insurance coverage for each vehicle class of the plurality of vehicle classes based on the information describing the market rental price for each vehicle class of the plurality of vehicle classes; and
presenting to the user an indication of a premium, from the plurality of premiums, that corresponds to the one vehicle class.

14. The apparatus of claim 13, wherein receiving information describing the market rental price for each vehicle class of the plurality of vehicle classes comprises:
receiving information describing the market rental prices for a plurality of geographic areas for each vehicle class of the plurality of vehicle classes; and
wherein calculating the premium for rental insurance coverage further comprises:
calculating a premium for rental insurance coverage for at least one geographic area among the plurality of geographic areas for each vehicle class of the plurality of vehicle classes based on the information describing the market rental price for each vehicle class of the plurality of vehicle classes.

15. The apparatus of claim 13, wherein presenting to the user the indication of the one vehicle class for use in the vehicle rental insurance transaction comprises:
presenting to the user an indication of the one vehicle class and the premium corresponding to the one vehicle class for use in the vehicle rental insurance transaction.

16. The apparatus of claim 13, the operations further comprising:
receiving information describing the market rental prices for a plurality of optional add-ons that are available to rent;
calculating an add-on premium for rental insurance coverage for each add-on of the plurality of optional add-ons based on the information describing the market rental prices for the plurality of optional add-ons; and
presenting to the user an indication of at least one add-on premium.

17. A method, implemented using a computing system, for managing vehicle rental insurance, the method comprising:
defining a plurality of vehicle classes, wherein each vehicle class among the plurality of vehicle classes has a set of identifying characteristics;
receiving, by the computing system, information describing a rental price for each vehicle class of the plurality of vehicle classes;
computing, by the computing system, a plurality of premiums for rental insurance corresponding to the plurality of vehicle classes, wherein each premium among the plurality of premiums is based on the rental price for a respective vehicle class;
presenting to a user, by the computing system, an indication of the plurality of vehicle classes and the plurality of premiums; and
receiving from the user an indication of a selection of one of the plurality of vehicle classes.

18. The method of claim 17, further comprising:
issuing new rental insurance according to the selection of one of the plurality of vehicle classes and a premium for rental insurance corresponding to the selection.

19. The method of claim 17, further comprising:
renewing rental insurance according to the selection of one of the plurality of vehicle classes and a premium for rental insurance corresponding to the selection.

20. The method of claim 17, further comprising:
presenting to the user, by the computing system, an indication of a plurality of optional add-ons and a plurality of corresponding add-on premiums; and
receiving from the user an indication of a selection of one or more of the plurality of optional add-ons.

21. The method of claim 20, further comprising:
computing a premium for rental insurance based on the selection from the user of one of the plurality of vehicle classes and the selection from the user of one or more of the plurality of optional add-ons.

22. The method of claim 17, further comprising:
receiving, by the computing system, information describing a covered vehicle;
computing, by the computing system, a recommendation of a comparable vehicle class from among the plurality of vehicle classes based a correspondence between the information describing the covered vehicle and the set of identifying characteristics of the comparable vehicle class; and
presenting to the user, by the computing system, the recommendation of the comparable vehicle class.

23. The method of claim 17, wherein computing the plurality of premium prices further comprises:
adjusting the plurality of premiums for rental insurance based on geographical differences in the rental prices for each vehicle class of the plurality of vehicle classes and a location of the user.
